(19) United States
(12) Patent Application Publication
(10) Pub. No.: US 2018/0029149 A1
(43) Pub. Date: Feb. 1, 2018

(54) Remotely Powered Cutting Assembly

(71) Applicant: Gabriel Ortiz, E Palo Alto, CA (US)

(72) Inventor: Gabriel Ortiz, E Palo Alto, CA (US)

(21) Appl. No.: 15/205,840

(22) Filed: Jul. 27, 2016

(51) Int. Cl. B23D 57/02; B23D 59/00

(52) U.S. Cl. CPC B23D 57/023; B23D 59/00

(57) ABSTRACT

A remotely powered cutting assembly includes a power unit that may be worn. A cutting unit is provided and the cutting unit may be manipulated thereby facilitating the cutting unit to cut objects. The cutting unit is in mechanical communication with the power unit. Thus, the cutting unit may inhibit hands from being exposed to vibration associated with the power unit thereby inhibiting development of carpal tunnel syndrome.

### BACKGROUND OF THE DISCLOSURE

### Field of the Disclosure

The disclosure relates to cutting devices and more particularly pertains to a new cutting device having a remote power unit with respect to a cutting unit.

### SUMMARY OF THE DISCLOSURE

An embodiment of the disclosure meets the needs presented above by generally comprising a power unit that may be worn. A cutting unit is provided and the cutting unit may be manipulated thereby facilitating the cutting unit to cut objects. The cutting unit is in mechanical communication with the power unit. Thus, the cutting unit may inhibit hands from being exposed to vibration associated with the power unit thereby inhibiting development of carpal tunnel syndrome.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a remotely powered cutting assembly according to an embodiment of the disclosure.

FIG. 2 is a perspective view of an alternative embodiment of the disclosure.

FIG. 3 is a back phantom view of power unit of an embodiment of the disclosure.

FIG. 4 is a right side phantom view of power unit of an embodiment of the disclosure.

FIG. 5 is a right side view of cutting unit of an embodiment of the disclosure.

### DESCRIPTION OF THE PREFERRED EMBODIMENT

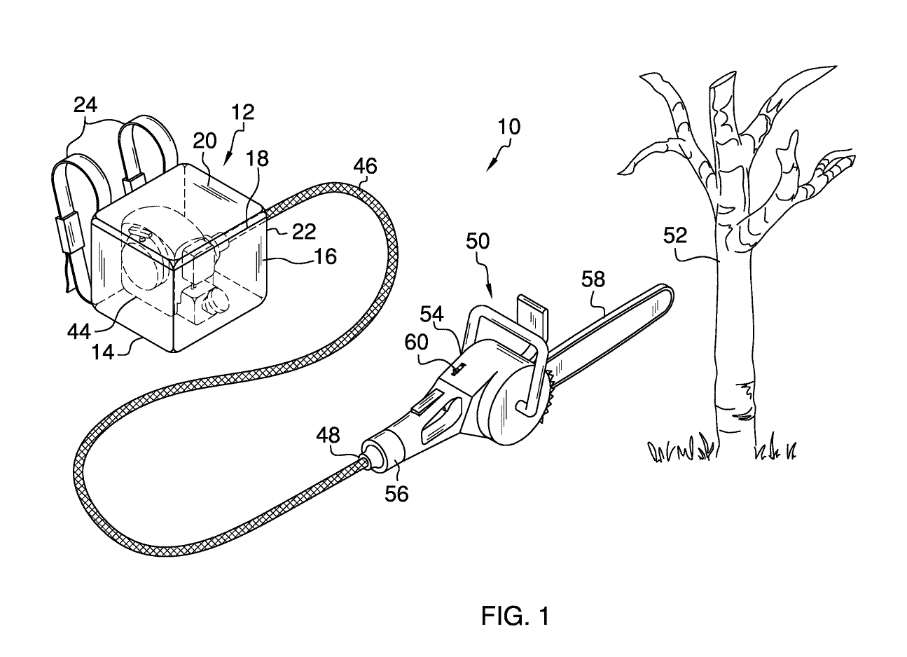

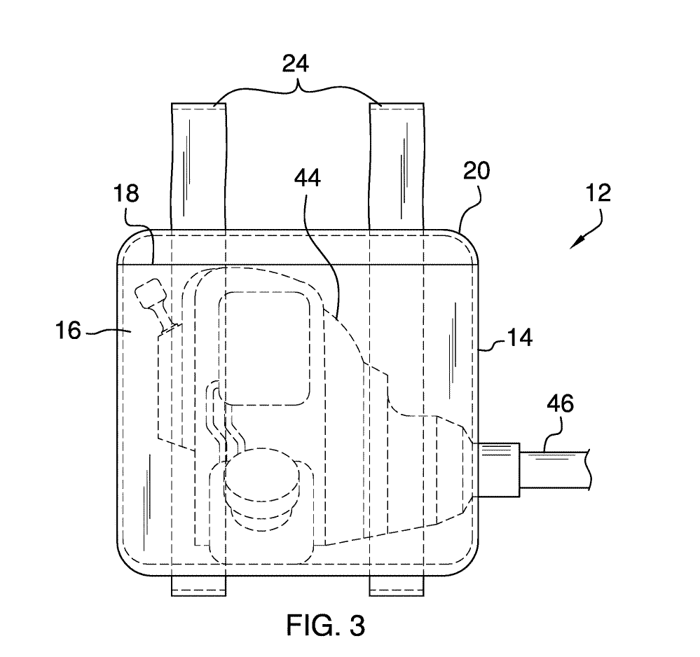

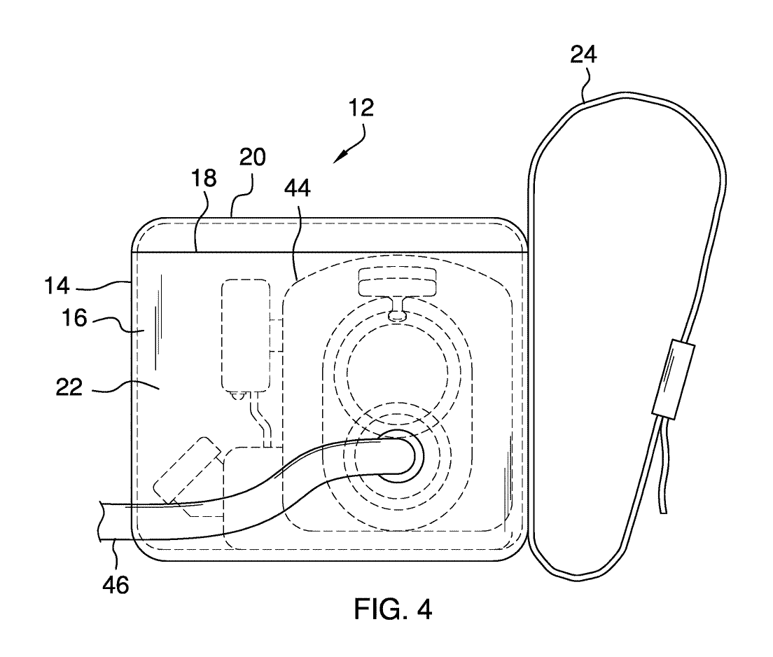

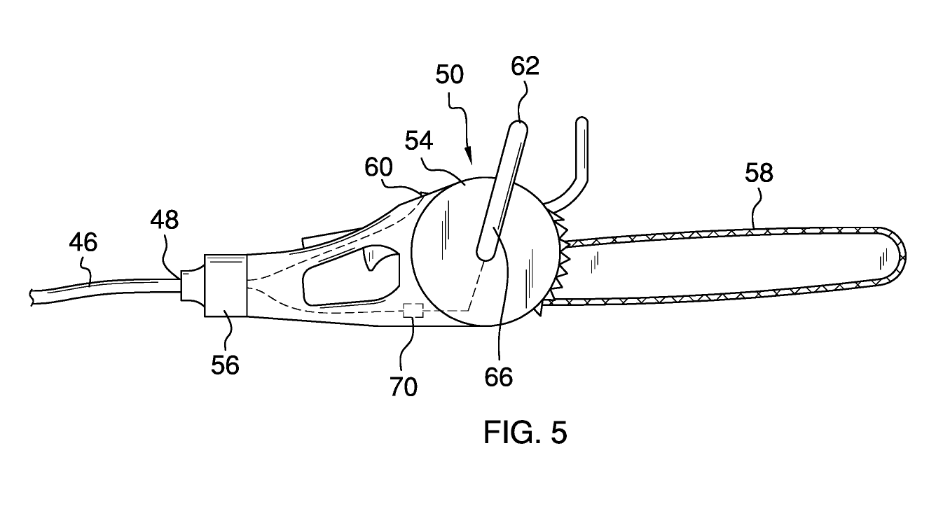

With reference now to the drawings, and in particular to FIGS. 1 through 5 thereof, a new cutting device embodying the principles and concepts of an embodiment of the disclosure and generally designated by the reference numeral 10 will be described.

As best illustrated in FIGS. 1 through 5, the remotely powered cutting assembly 10 generally comprises a power unit 12 that may be worn. The power unit 12 comprises a box 14 that has an outer wall 16 and a top side 18. The top side 18 is open to access an interior of the box 14. A lid 20 is provided and the lid 20 is removably positioned on the top side 18. The outer wall 16 has a first lateral side 22.

A pair of straps 24 is provided and each of the straps 24 is coupled to the outer wall 16. Thus, each of the straps 24 may be extended over an associated one of a pair of shoulders thereby facilitating the box 14 to be worn. Each of the straps 24 is matable to themselves such that each of the straps 24 forms a closed loop. Moreover, each of the straps 24 may have an adjustable length.

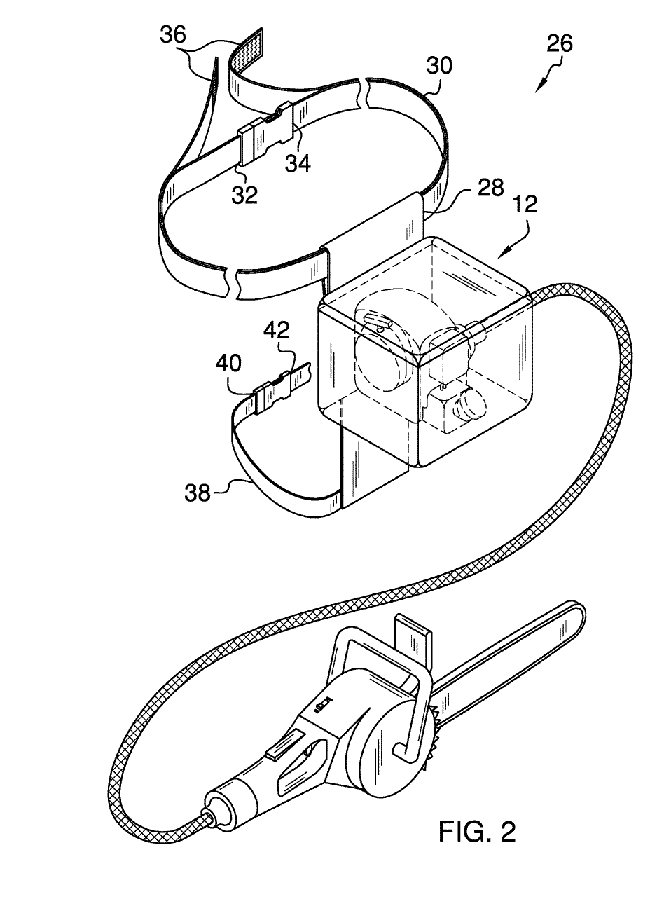

In an alternative embodiment 26 as shown in FIG. 2, a sleeve 28 may be coupled to the outer wall 16 of the box 14. A first belt 30 may be provided and the first belt 30 may have a first end 32 and a second end 34. The first belt 30 may be extended through the sleeve 28 and the first belt 30 may be worn around a waist. The first end 30 is matable to the second end 34. Thus, the box 14 may be worn.

Continuing in the alternative embodiment 26, the first belt 30 may include a pair of auxiliary straps 36. The auxiliary straps 36 are matable to each other. Thus, the auxiliary straps 36 may facilitate additional security when the box 14 is worn. Each of the auxiliary straps 36 may comprise complementary hook and loop fasteners or the like.

The alternative embodiment 26 may include a second belt 38 that may be attached to the outer wall 38 of the box 14. The second belt 38 may have a primary end 40 and a secondary end 42. The second belt 38 may be worn around a leg. The primary end 40 is matable to the second end 42. Thus, the box 14 may be worn.

A motor 44 is provided and the motor 44 is positioned within the box 14. The motor 44 may comprise an internal combustion motor or the like. A drive shaft 46 is mechanically coupled to the motor 44. Thus, the motor 44 rotates the drive shaft 46 when the motor 44 is turned on.

The drive shaft 46 extends outwardly from the outer wall 38 of the box 14. Moreover, the drive shaft 46 has a distal end 48 with respect to the box 14. The drive shaft 46 is comprised of a flexible material. The drive shaft 46 may comprise a flexible central member rotatably extending through an outer sheath or the like. The drive shaft 46 may extend outwardly from the first lateral side 22 of the box 14. Thus, the drive shaft 46 may extend laterally away from a user when the box 14 is worn.

A cutting unit 50 is provided. The cutting unit 50 may be manipulated thereby facilitating the cutting unit 50 to cut objects 52. The objects 52 may be tree trunks, tree branches and other forms of vegetative brush. The cutting unit 50 is in mechanical communication with the power unit 12. Thus, the cutting unit 50 inhibits hands from being exposed to vibration associated with the power unit 12 thereby inhibiting development of carpal tunnel syndrome. Moreover, the remote positioning of the power unit 12 with respect to the cutting unit 50 inhibits the hands from supporting the weight of the power unit 12. Thus, the cutting unit 50 reduces muscular fatigue associated with carrying the power unit 12 with hands.

The cutting unit 50 comprises a chainsaw 54 that may be manipulated. The chain saw 54 has a drive 56 and a blade 58 is that mechanically coupled to the drive 56. Thus, the drive 56 rotates the blade 58 when the drive 56 rotates. The drive 56 may comprise a mechanical drive or the like and the blade 58 may comprise a chain saw blade or the like.

The distal end 48 of the drive shaft 46 is mechanically coupled to the drive 56. The drive shaft 46 rotates the drive 56 when the motor 44 is turned on. Thus, the chainsaw 54 may cut the objects 52. The chainsaw 54 may include a handle, a chain guard, a trigger and other conventional, mechanical elements of a motorized chainsaw.

A switch 60 is coupled to the chainsaw 54 and the switch 60 may be manipulated. The switch 60 is electrically coupled to the drive 56. The switch 60 selectively disengages and engages the drive 56 with respect to the drive shaft 46. Thus, the switch 60 selectively inhibits and facilitates the drive shaft 46 to rotate the blade 58. The switch 60 may be in mechanical communication with the drive 56 through any conventional means such as an electronic clutch or the like.

A grip 62 is provided. The grip 62 has a central member 64 extending between a pair of lateral members 66. The lateral members 66 are spaced apart from each other such that the grip 62 has a U-shape. Each of the lateral members 66 has a distal end 68 with respect to the central member 64. The distal end 68 corresponding to each of the lateral members 66 is coupled to the chainsaw 54. The central member 64 is spaced from the chainsaw 54 and the central member 64 may be gripped. The grip 62 is comprised of an electrically conductive material. The grip 62 is between the blade 58 and the drive 56.

A touch sensor 70 is provided and the touch sensor 70 is coupled to the chainsaw 54. The touch sensor 70 is electrically coupled to the grip 62. Thus, the touch sensor 70 senses when the grip 62 is touched. The touch sensor 70 is electrically coupled to the drive 56. The touch sensor 70 turns the drive 56 on when the touch sensor 70 senses the grip 62 is touched. Moreover, the touch sensor 70 turns the drive 56 off when the touch sensor 70 does not sense the grip 62 is touched. Thus, the blade 58 does not move when the grip 62 is not gripped thereby enhancing safety of the chainsaw 54.

In use, the box 14 is worn in the previously described manner. The motor 44 is started and the chainsaw 54 is held. The remote location of the motor 44 with respect to the chainsaw 54 inhibits the user's hands from being exposed to vibration from the motor 44. Thus, the user's hands are inhibited from developing symptoms of carpal tunnel syndrome related to the vibration from the motor 44. The switch 60 is manipulated and the grip 62 is gripped to selectively actuate and de-actuate the blade 58. The chainsaw 54 is manipulated to cut the objects 52.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A remotely powered cutting assembly being configured to reduce vibration and weight associated with operating a cutting unit, said assembly comprising:
a power unit being configured to be worn; and
a cutting unit being configured to be manipulated thereby facilitating said cutting unit to cut objects, said cutting unit being in mechanical communication with said power unit wherein said cutting unit is configured to inhibit hands from being exposed to vibration associated with said power unit thereby inhibiting development of carpal tunnel syndrome.

2. The assembly according to claim 1, wherein said power unit comprises:
a box having an outer wall and a top side, said top side being open to access an interior of said box; and
a lid being removably positioned on said top side.

3. The assembly according to claim 2, further comprising a pair of straps, each of said straps being coupled to said outer wall wherein each of said straps is configured to be extended over an associated one of a pair of shoulders thereby facilitating said box to be worn, each of said straps being matable to themselves such that each of said straps forms a closed loop.

4. The assembly according to claim 2, further comprising a motor being positioned within said box.

5. The assembly according to claim 4, further comprising a drive shaft being mechanically coupled to said motor such that said motor rotates said drive shaft when said motor is turned on, said drive shaft extending outwardly from said outer wall of said box, said drive shaft having a distal end with respect to said box, said drive shaft being comprised of a flexible material.

6. The assembly according to claim 1, wherein:
said power unit includes a drive shaft, said drive shaft having a distal end; and
said cutting unit comprises a chainsaw being configured to be manipulated, said chain saw having a drive and a blade being mechanically coupled to said drive such that said drive rotates said blade when said drive rotates, said distal end of said drive shaft being mechanically coupled to said drive such that said drive shaft rotates said drive when said motor is turned on wherein said chainsaw is configured to cut the objects.

7. The assembly according to claim 6, further comprising a switch being coupled to said chainsaw wherein said switch is configured to be manipulated, said switch being electrically coupled to said drive, said switch selectively disengaging and engaging said drive from said drive shaft such that said switch selectively inhibits and facilitates said drive shaft to rotate said blade.

8. A remotely powered cutting assembly being configured to reduce vibration and weight associated with operating a cutting unit, said assembly comprising:
a power unit being configured to be worn, said power unit comprising:
a box having an outer wall and a top side, said top side being open to access an interior of said box,
a lid being removably positioned on said top side,
a pair of straps, each of said straps being coupled to said outer wall wherein each of said straps is configured to be extended over an associated one of a pair of shoulders thereby facilitating said box to be worn, each of said straps being matable to themselves such that each of said straps forms a closed loop,
a motor being positioned within said box, and
a drive shaft being mechanically coupled to said motor such that said motor rotates said drive shaft when said motor is turned on, said drive shaft extending outwardly from said outer wall of said box, said drive shaft having a distal end with respect to said box, said drive shaft being comprised of a flexible material; and
a cutting unit being configured to be manipulated thereby facilitating said cutting unit to cut objects, said cutting unit being in mechanical communication with said power unit wherein said cutting unit is configured to inhibit hands from being exposed to vibration associated with said power unit thereby inhibiting development of carpal tunnel syndrome, said cutting unit comprising:
a chainsaw being configured to be manipulated, said chain saw having a drive and a blade being mechanically coupled to said drive such that said drive rotates said blade when said drive rotates, said distal end of said drive shaft being mechanically coupled to said drive such that said drive shaft rotates said drive when said motor is turned on wherein said chainsaw is configured to cut the objects, and
a switch being coupled to said chainsaw wherein said switch is configured to be manipulated, said switch being electrically coupled to said drive, said switch selectively disengaging and engaging said drive from said drive shaft such that said switch selectively inhibits and facilitates said drive shaft to rotate said blade.
